(19) United States
(12) Patent Application Publication
(10) Pub. No.: US 2011/0081606 A1
(43) Pub. Date: Apr. 7, 2011

(54) ELECTROSTATIC IMAGE DEVELOPING TONER AND IMAGE FORMING METHOD

(75) Inventors: Hidemasa SAWADA, Tokyo (JP); Kazuhiko NAKAJIMA, Tokyo (JP); Miyuki MURAKAMI, Kanagawa (JP)

(73) Assignee: KONICA MINOLTA BUSINESS TECHNOLOGIES, INC., Tokyo (JP)

(21) Appl. No.: 12/892,549

(22) Filed: Sep. 28, 2010

(30) Foreign Application Priority Data
Oct. 1, 2009 (JP) 2009229179

(51) Int. Cl. G03G 13/08; G03G 9/08

(52) U.S. Cl. 430/42.1; 430/107.1

(57) ABSTRACT

Disclosed is an electrostatic image developing toner comprised of toner particles containing a binding resin and a coloring agent, and the coloring agent contains a black color material and a cyan color material, the content of the black color material being 0.5 to 3 parts by mass with respect to 100 parts by mass of the above binding resin, as well as the content of the cyan color material being 0.1 to 0.5 parts by mass with respect to 100 parts by mass of the above binding resin.

This application is based on Japanese Patent Application No. 2009-229179 filed on Oct. 1, 2009, in Japanese Patent Office, the entire content of which is hereby incorporated by reference.

### TECHNICAL FIELD

The present invention relates to an electrostatic image developing toner, and an image forming method using the same.

### BACKGROUND TECHNOLOGY

In an image forming method of an electrophotographic system, it has been proposed to improve image gradation and graininess using gray toner (refer, for example, to Patent Documents 1 to 3).

However, there is a problem that, when, for example, an inked image is formed using such the gray toner, people notice that the image has a hue with a slight reddish tinge. There is also a problem that a hue angle is subtly shifted depending on the attached amount of the toner, but in general a single color image composed of gray toner appears sepia. The reason why such problem is generated is that an overwhelming majority of black color materials such as carbon black and black dye has a characteristic that the finer the color materials being dispersed by making them fine particles, the more clearly the color material has a reddish tinge. In toner particles, an attainment of the fine dispersion of the black color materials gives excellent development transferability, and thereby a high quality image can be formed.

On the other hand, in color photographs and other color images, color vividness has been demanded, and thereby, the development of new color materials has been progressing (refer, for example, to Patent Documents 4 and 5). The use of such the newly developed color toners enabled an image in which color chroma and lightness are improved, but in contrast to them, a problem was generated that reproduction of a somber intermediate color becomes difficult.

Specifically, a problem arose that, contrary to a “vivid tone (a pure color) having high chroma and lightness”, a dark grayish tone having low chroma and lightness (a shade color), and a “dark tone” having slightly higher chroma and lightness than the dark grayish tone but is a impure color having a black shade compared to the vivid tone shift to a reddish tone or a sepia color.

The dark tone and the dark grayish tone are important color tones, which represent shadow of photograph. Further, since the dark tone and the dark grayish tone are hard and heavy tones, they are often used for a building or cloth. The above tones include, for example, BLEU NUIT, and BORDEAUX FONCE, which are French traditional colors; viridian green and deep purplish blue, which are Chinese traditional colors; and evergreen and perse, which are Japanese traditional colors.

However, there is a problem that, the dark grayish tone image and the dark tone image are influenced by a reddish tinge developed by inking by the gray toner, and thereby, expected color tone is not obtained.

In general, since printed matters, in which product images such as an advertising photo are printed, reduce buyer's willingness to buy when there is a divergence from expected color tone, color reproduction of the printed matters is severely required.
Patent Document 1: Japanese Patent Application Publication (hereinafter also referred to as JP-A) No. H11-84764
Patent Document 2: JP-A No. 2004-133247
Patent Document 3: JP-A No. 2006-227308
Patent Document 4: JP-A No. 2007-140478
Patent Document 5: JP-A No. 2007-34264

### SUMMARY OF THE INVENTION

The present invention has been achieved based on the above circumstances, and its purpose is to provide an electrostatic image developing toner by which excellent color development relating to gray color can be obtained.

Further, the other purpose is to provide an image forming method in which excellent color reproduction even in a high quality medium tone image can be obtained.

The electrostatic image developing toner of the present invention is characterized in that an electrostatic image developing toner comprising toner particles containing a binding resin and a coloring agent,

the above-described coloring agent contains a black color material and a cyan color material, and

the content of the black color material constituting the above coloring agent is 0.5 to 3 parts by mass with respect to 100 parts by mass of the above binding resin, as well as the content of the cyan color material constituting the above coloring agent being 0.1 to 0.5 parts by mass with respect to 100 parts by mass of the above binding resin.

In the electrostatic image developing toner of the present invention, the content ratio between the above cyan color material and the above black color material, both of which constitute the above coloring agent, is preferably in the range of 1:1 to 1:20 by mass ratio.

In the electrostatic image developing toner of the present invention, the above black color material is preferably carbon black or black dye.

The image forming method of the present invention is a method for forming a visual image by repeating two times or more of a toner image forming step, using different color toners, which step forms a toner image which is formed by visualizing an electrostatic latent image formed on an electrostatic latent image bearing body using toner,

wherein one of two or more toner image forming steps is carried out using the above electrostatic image developing toner.

According to the electrostatic image developing toner of the present invention, even in case where the black color materials are homogeneously finely dispersed in binding resin, since the cyan color materials are also incorporated in the aforesaid binding resin, a reddish tinge such as brown and sepia developed by a characteristic of the black color material is toned, whereby, as a whole, preferable color development relating to gray can be obtained.

According to the image forming method of the present invention, the use of the above-described toner enables to tone a reddish tinge, such as brown and sepia, and thereby to form a high quality medium tone image, in which an excellent color reproduction was obtained. In particular, in case of forming a tone image, in which a little inking is needed, specifically a dark grayish or dark tone image, there can be surely obtained an effect to reproduce an expected color tone and form a high quality medium tone image.

In addition, a medium tone image having a rich texture can be formed. It is assumed that this is because an excellent density gradation is achieved. Namely, when an image takes on a slight blue tinge in an achromatic medium tone, the image is recognized as a shadow, and thereby, a change in lightness can be readily visually noticed. According to the image forming method of the present invention, it is assumed that, since toner incorporates a cyan color material, natural shade is formed.

### BRIEF DESCRIPTION OF DRAWING

FIG. 1 is a cross section for explanation showing an example of a constitution of an image forming apparatus which is used for an image forming method using the electrostatic image developing toner of the present invention.

### MODE FOR CARRYING OUT THE INVENTION

The present invention will be detailed below.

The electrostatic image developing toner of the present invention (hereinafter also referred to as “gray toner”) comprises toner particles containing a binding resin and a coloring agent, and the coloring agent contains a black color material and a cyan color material. The content of the black color material is 0.5 to 3 parts by mass with respect to 100 parts by mass of the binding resin, and the content of the cyan color material is 0.1 to 0.5 parts by mass with respect to 100 parts by mass of the binding resin. Hereinafter, such toner particles are referred to as gray toner particles.

In the gray toner particles, since each of contents of the black color material and the cyan color material is in the above-described ranges, the color from the gray toner is restrained from taking on a red tinge. On the other hand, in case where the content of the black color material is less than 0.5 parts by mass with respect to 100 parts by mass of the binding resin, the gray density becomes less, and thereby, sufficient coloring power may not be obtained, and in case where the content of the black color material exceeds 3 parts by mass with respect to 100 parts by mass of the binding resin, the gray becomes darker, and the density difference from the color from black toner becomes less, and thereby, excellent graininess in highlight areas in the formed image may not be obtained.

In the gray toner particles, the content ratio between the cyan color material and the black color material, both of which constitute the coloring agent, is in the range of 1:1 to 1:20 by mass, and preferably in the range of 1:2 to 1:15 by mass.

In the gray toner particles, since the content ratio between the cyan color material and the black color material, both of which constitute the coloring agent, is in the above-described range, an effect of a color from the gray toner being restrained from taking on a red tinge can be secured. On the other hand, in case where the content ratio of the cyan color material to the black color material is excessively small, a color from the gray toner may take on a red tinge, and in case where the content ratio of the cyan color material to the black color material is excessively large, though the reddish tinge is toned, a color from the gray toner shifts as a whole to a color in the blue range, and thereby, the color to be developed may take on a color tinge in the blue range.

### [Black Color Material]

In the present invention, the black color material means a achromatic color material defined by the following manner: a black image, formed on the POD gloss coated paper (produced by Oji Paper Co., Ltd.) having an amount of toner attached of 4 g/m² using toner produced with 10 parts by mass of the above achromatic color material being added to 100 parts by mass of binding resin, exhibits chroma of 5 or less as defined by L*a*b* color system.

The L*a*b* color system is a useful means which is used to quantify a color. The L* in the z axis direction indicates lightness. The a* in the x axis direction and the b* in the y axis direction indicate a hue of red-green direction and a hue of yellow-blue direction, respectively, and a combination of the a* and the b* indicates chroma. The lightness indicates the relative lightness of color, the hue indicates a tone of color such as red, yellow, green, blue and purple, and the chroma indicates a degree of vividness of color.

Specifically, the chroma refers to a distance of a certain coordinate point (a, b) from the origin O in an x-y axis plane representing a relationship between the hue and the chroma when, for example, the lightness has a certain value, and is calculated by the following Formula (C).

Chroma (C*)=[(a*)²+(b*)²]^{1/2}, Formula (C):

wherein a* and b* of above Formula (C) represent values of a and b at a coordinate point (a, b) respectively.

Specifically, the L*a*b* for calculation of the chroma C* is determined using the GRETAG MACBETH SPECTROLINO (manufactured by Gretag Macbeth) with conditions that D65 is used as a light source, an aperture of 4 mm in diameter used for reflection measurement is used, at an interval of 10 nm in the range of 380 to 730 nm of the measuring wavelength, the viewing angle is set to 2 degrees (an observer), and a white tile for exclusive use is used for a calibration.

As the black color material as the coloring agent incorporated in the gray toner particles constituting the gray toner of the present invention, usable are, for example, acidic or alkaline carbon black, magnetite, or a black dye, and in particular acidic carbon black or a black dye is preferably used. Specifically, the commercially available acidic carbon black includes MA-7, MA-77, MA-100, MA-1005, and MA-200 (produced by Mitsubishi Chemical Corp.), and alkaline carbon black includes #25, #10, and #5 (produced by Mitsubishi Chemical Corp.), and furthermore, the commercially available black dye includes OIL BLACK 803, and OIL BLACK HBB (produced by Orient Chemical Ind. Co., Ltd.), AIZEN SOT DYE BCLACK-1, AIZEN SOT DYE BCLACK-4, AIZEN SOT DYE CLACK-6, and AIZEN SOT DYE CLACK-8 (produced by Hodogaya Chemical Co., Ltd.), and KAYALON POLYESTER BLACK EX-SF 300 (produced by Nippon Kayaku Co., Ltd.)

### [Cyan Color Material]

In the present invention, the cyan color material is a color material defined by the following manner: a cyan image, formed on the POD gloss coated paper (produced by Oji Paper Co., Ltd.) having an amount of toner attached of 4 g/m² using toner produced with 10 parts by mass of the cyan color material being added to 100 parts by mass of binding resin, exhibits a hue angle of 180 to 220 degrees, and chroma of 25 or more as defined by L*a*b* color system.

Specifically, the hue angle refers to an angle between a half line between a certain coordinate point (a, b) and the origin O and a line extending to a plus direction of an x axis in an anti-clockwise direction from a plus direction of an x axis (being a red direction) in an x-y axis plane representing a relationship between the hue and the chroma when, for example, the lightness has a certain value, and is calculated by the following Formula (H). In an x-y axis plane, a minus direction of an x axis represented by a* is a green direction, a plus direction of a y axis represented by b* is a yellow direction, and a minus direction of the aforesaid y axis is a blue direction.

Hue angle=tan⁻¹(b*/a*), Formula (H):

wherein a* and b* of above Formula (H) represent values of a and b at a coordinate point (a, b) respectively.

Specifically, the L*a*b* for calculation of the hue angle is determined using the GRETAG MACBETH SPECTROLINO (manufactured by Gretag Macbeth) with conditions that D65 is used as a light source, an aperture of 4 mm in diameter for reflection measurement is used, at an interval of 10 nm in the range of 380 to 730 nm of the measuring wavelength, the viewing angle is set to 2 degrees (an observer), and an exclusive white tile is used for a calibration.

As the cyan color material as the coloring agent incorporated in the gray toner particles constituting the gray toner of the present invention, included are a cyan series color materials such as C.I. Pigment Blue 15 series, specifically C.I. pigment blue 15:1, C.I. pigment blue 15:2, C.I. pigment blue 15:3, and C.I. pigment blue 15:4, C.I. pigment blue 16, C.I. pigment blue 60, C.I. pigment blue 62, and C.I. pigment blue 76; and a blue series color materials such as C.I. Solvent Blue 63, C.I. Solvent Blue 87, C.I. Solvent Blue 97, C.I. Solvent Blue 104, C.I. Solvent Blue 136, Solvent Violet 13, and Solvent Violet 36. Of these, particularly preferable are C.I. pigment blue 15:3, C.I. pigment blue 16, C.I. pigment blue 76, and C.I. Solvent Blue 63.

### [Binding Resin]

The binding resin incorporated in the gray toner particles constituting the gray toner of the present invention includes, in case where the gray toner particles are produced by a method such as a pulverization method and a dissolution suspension method, vinyl series resin such as styrene series resin, (meth)acryl series resin, styrene-(meth)acryl series copolymer resin, and olefin series resin, polyester series resin, polyamide series resin, polycarbonate series resin, polyether series resin, polyvinyl acetate series resin, polysulfone resin, epoxy resin, polyurethane resin, and urea resin.

In case where the gray toner particles are produced by a method such as a suspension polymerization method, a mini emulsion polymerization and coagulation method, and an emulsion polymerization and coagulation method, polymerizable monomer for obtaining each resin constituting the gray toner particles includes various polymerizable monomers such as vinyl series monomer. The polymerizable monomer is preferably used as a combination with other polymerizable monomer having an ionic dissociable group. Further, as the polymerizable monomer, the binding resin having a cross-linked structure can also be obtained using a polyfunctional vinyl series monomer.

The gray toner particles constituting the gray toner of the present invention may, if desired, further incorporate a charge control agent, magnetic powder, a releasing agent, and the like.

### [Magnetic Powder]

In case where the gray toner particles are constituted with magnetic powder being incorporated, as the magnetic powder, usable is, for example, magnetite, γ-hematite, or various kinds of ferrite.

The content ratio of the magnetic powder is preferably 10 to 500 parts by mass, and more preferably 20 to 200 parts by mass, with respect to 100 parts by mass of the binding resin constituting the gray toner particles.

### [Charge Control Agent]

In case where the gray toner particles are constituted with a charge control agent being incorporated, as the charge control agent, various substances can be used as long as the substance can provide a positive or negative charge via triboelectric charging. Specifically, the positive charge control agent includes, for example, nigrosine series dye such as NIGROSINE BASE EX (produced by Orient Chemical Industries Ltd.); tert-ammonium salt such as Tert-Ammonium Salt P-51 (produced by Orient Chemical Industries Ltd.), COPY CHARGE PX VP435 (produced by Hoechst Japan), and imidazole compound such as alkoxylated amine, alkylamide, molybdic acid chelate pigment, and PLZ-1001 (produced by Shikoku Chemicals Corp.). The negative charge control agent includes, for example, metal complex such as BONTRON S-22 (produced by Orient Chemical Industries Ltd.), BONTRON S-34 (produced by Orient Chemical Industries Ltd.), BONTRON E-81 (produced by Orient Chemical Industries Ltd.), BONTRON E-84 (produced by Orient Chemical Industries Ltd.), and SPILON BLACK TRH (produced by Hodogaya Chemical Co., Ltd.); thioindigo series pigment; tert-ammonium salt such as COPY CHARGE NX VP434 (produced by Hoechst Japan); calixarene compound such as BONTRON E-89 (produced by Orient Chemical Industries Ltd.); boron compound such as LR-147 (produced by Japan Carlit Co., Ltd.); and fluorine compound such as magnesium fluoride, and carbon fluoride. As the metal complex used as the negative charge control agent, usable are metal complexes having various structures, such as oxycarboxylic acid metal complex, dicarboxylic acid metal complex, amino acid metal complex, diketone metal complex, diamine metal complex, azo group containing benzene-benzene derivative frame metal complex, and azo group containing benzene-naphthalene derivative frame metal complex.

As described above, by the gray toner particles being constituted with a charge control agent being incorporated, the charging characteristic of the gray toner can be improved.

The content ratio of the charge control agent is preferably 0.01 to 30 parts by mass, and more preferably 0.1 to 10 parts by mass, with respect to 100 parts by mass of the binding resin constituting the gray toner particles.

### [Releasing Agent]

In case where the gray toner particles are constituted with a releasing agent being incorporated, as the releasing agent, various waxes can be used. As the wax, preferably usable are polyolefin type waxes such as low molecular polypropylene and polyethylene, and oxidized polypropylene and polyethylene.

The content ratio of the releasing agent is preferably 0.1 to 30 parts by mass, and more preferably 1 to 10 parts by mass, with respect to 100 parts by mass of the binding resin constituting the gray toner particles.

The gray toner particles constituting the gray toner of the present invention may have a core-shell structure, which is composed of a core particle incorporating a binding resin and a coloring agent, and a shell layer composed of shell layer forming resin containing substantially no coloring agent (hereinafter also referred to as “shell resin”), which layer covers the outer circumferential surface of the above core particle. With the gray toner particles being constituted of the core-shell structure, the aforesaid gray toner particles can have a high production stability and storage stability.

The gray toner particle having the above core-shell structure may be not only a form in which the shell layer completely covers the core particle, but also a form in which the shell layer covers a part of the core particle. There may also be a form that a part of the shell resin constituting the shell layer forms a domain and the like in the core particle. Further, there may also be a form that the shell layer has a multilayer structure of two or more layers composed of resins having a different composition.

### [Production Method of Gray Toner]

The method for producing the gray toner of the present invention includes a kneading and pulverization method, a suspension polymerization method, an emulsion polymerization method, an emulsion polymerization and coagulation method, a mini emulsion polymerization and coagulation method, and an encapsulation method. Of these, from a viewpoint of a production cost and stability, the emulsion polymerization and coagulation method is preferably used, in consideration that it is necessary to obtain gray toner composed of small-sized particles to achieve a high quality image. The emulsion polymerization and coagulation method is a method to produce the gray toner particles in such a way that a dispersion of particulates composed of binding resin produced by a emulsion polymerization method (hereinafter also referred to “binding resin particulates”) is mixed with a dispersion of particulates composed of coloring agents (hereinafter also referred to “coloring agent particulates”), which mixture is then slowly coagulated while taking a balance of the surface repulsive force of particulates by pH adjustment and the coagulation force by addition of coagulant composed of electrolytes, and then, fusion bonding between the particulates is carried out by carrying out association between them while controlling the average particle size and the particle distribution, and, at the same time, heating and stirring is carried out for controlling the shape.

In the method for producing the gray toner, the binding resin particulates, which are formed in case of using the emulsion polymerization and coagulation method may have a constitution of two or more layers composed of binding resins having different compositions. In this case, there can be used a method in which polymerization initiators and polymerizable monomers are added into the dispersion of the first resin particles prepared by an emulsion polymerization treatment base on the conventional method (the first step polymerization), and then, the above mixture is subjected to a polymerization treatment (the second step polymerization).

The gray toner particles having the core-shell structure can be obtained in such a manner that core particles are prepared by, first of all, associating, coagulating, and fusion bonding the binding resin particulates and coloring agent particulates used for the core particles, and subsequently the binding resin particulates for a shell layer used for forming the shell layer are added into a core particle dispersion, and then, the shell layer to cover the core particle surface is formed by coagulating and fusion bonding the above binding resin particulates for a shell layer on the above-described core particle surface.

### [Size of Gray Toner Particle]

The size of the gray toner particle constituting the above gray toner has preferably, for example, a volume-based median size of 4 to 10 μm, and more preferably 5 to 9 μm.

The volume-based median size being in the above range increases a transfer efficiency to improve the quality of halftone-image, and improves quality of narrow lines, and dot images.

The volume-based median size of the gray toner particle is measured and calculated via a measuring apparatus in which the COULTER MULTISIZER TA-III (manufactured by Beckman Coulter Inc.) is connected with a computer system for data processing (manufactured by Beckman Coulter Inc.). Specifically, the above measurement is carried out as follows: 0.02 g of gray toner is soaked in 20 ml of surface active agent solution (being a surface active agent solution, employed for the purpose of dispersion of the gray toner, which solution is prepared, for example, by diluting a neutral detergent containing a component of surface active agent by a factor of 10 in pure water) and the resulting mixture is subjected to an ultrasonic dispersion for one minute to prepare a gray toner dispersion. Then the gray toner dispersion is charged using a pipette into a beaker containing ISOTON II (produced by Beckman Coulter Inc.), placed on a sample stand, to achieve a measured concentration of 5% to 10%. By making the concentration to be within the above range, reproducible measured values can be obtained. In the measuring apparatus, the count of the measuring particles is set to 25,000, and the aperture size is set to 50 μm, a frequency value is calculated with a range of from 1 to 30 μm, in which the determination was performed, being divided into 256 portions, and then, a particle size at 50% from a large size of a cumulative volume fraction was used as the volume-based median size.

### [Average Circular Degree of Gray Toner Particle]

The gray toner of the present invention preferably has, on each of the gray toner particles constituting the gray toner, from a viewpoint of improvement of the transfer efficiency, the average circular degree, represented by Formula (T) below, of 0.930 to 1.000, and more preferably 0.950 to 0.995.

Circular degree=(Circumference of a circle determined from a diameter equivalent to a circle)/(Circumference of a projected particle image) Formula (T):

### [External Additive]

The above gray toner particles can be used as the gray toner having the constitution composed of the binder resin and coloring agent, but may have a constitution in which, to improve fluidity, a charging characteristic, cleaning property, and the like, an external additive such as a fluidity agent and a cleaning aid, which are a so-called post-treatment agent, is added to the aforesaid gray toner particles.

The post-treatment agent includes, for example, inorganic oxide particulates such as silica particulates, alumina particulates, and titanium oxide particulates; inorganic stearic acid compound particulates such as aluminum stearate particulates, and zinc stearate particulates; and inorganic titanic acid compound particulates such as strontium titanate, and zinc titanate. These particulates may be used singly or in combination of two or more.

It is preferable that these particulates are subjected to surface treatment by a silane coupling agent, titanium coupling agent, higher fatty acid or silicone oil to improve heat-resistant storage property and environmental stability.

The total amount of these various external additives to be added is 0.05 to 5 parts by mass, and preferably 0.1 to 3 parts by mass, with respect to 100 parts by mass of the gray toner. The external additives may be used as a combination of the various kinds thereof.

### [Chroma and Lightness of Gray Toner]

The gray toner preferably has chroma C* of 0 to 3 and lightness of 30 to 90 in single toner image. The single toner image is an image formed by the gray toner according to the invention having an amount of toner attached of 4 g/m² on a paper having lightness of 92, for example, “POD GLOSS COAT” (made of Oji Paper Co. Ltd.).

The L*a*b* for calculation of the chroma C* and lightness L* is determined using the GRETAG MACBETH SPECTROLINO (manufactured by Gretag Macbeth) with conditions that D65 is used as a light source, an aperture of 4 mm in diameter for reflection measurement is used, at an interval of 10 nm in the range of 380 to 730 nm of the measuring wavelength, the viewing angle is set to 2 degrees (an observer), and an exclusive white tile is used for a calibration.

The lightness L* of the toner is defined by the L*a*b* color system. The L*a*b* color system is a useful means which is used to quantify a color. The L* in the z axis direction indicates lightness. The a* in the x axis direction and the b* in the y axis direction indicate a hue of red-green direction and a hue of yellow-blue direction, respectively, and a combination of the a* and the b* indicates chroma. The lightness indicates the relative lightness of color, the hue indicates a tone of color such as red, yellow, green, blue and purple, and the chroma indicates a degree of vividness of color.

Specifically, the chroma refers to a distance of a certain coordinate point (a, b) from the origin 0 in an x-y axis plane representing a relationship between the hue and the chroma when, for example, the lightness has a certain value, and is calculated by the following Formula (C).

Chroma (C*)=[(a*)²+(b*)²]^{1/2}, Formula (C):

wherein a* and b* of above Formula (C) represent values of a and b at a coordinate point (a, b) respectively.

### [Developer]

The gray toner of the present invention may be used as a magnetic or non-magnetic single component developer, but may be used as a two-component developer mixed with a carrier. In case where the gray toner of the present invention is used as the two-component developer, usable as the carrier are magnetic particles composed of materials such as metals such as iron, ferrite and magnetite, and alloys of the foregoing metals and a metal such as aluminum, of which ferrite particles are particularly preferred. As the carrier, there may also be used a coated carrier in which the surface of the magnetic particle is covered with a covering agent such as resin, or a binder type carrier in which magnetic fine powder is dispersed in binder resin.

The covering resin constituting the coated carrier includes, for example, olefin series resin, styrene series resin, styrene-acryl series resin, silicone resin, ester resin, and fluorine resin. As the resin constituting the resin dispersion type carrier, fore example, styrene-acryl series resin, polyester resin, fluorine resin, and phenol resin can be used.

A volume-based median size of the carrier is preferably 20 to 100 μm, and more preferably 20 to 60 μm. The volume-based median size of the carrier is typically determined by a laser diffraction particle size distribution analyzer provided with a wet disperser (HELOS, manufactured by Sympatec Co., Ltd.).

According to the gray toner described above, even in case where a black material is homogeneously finely dispersed in binding resin, since cyan color materials are also incorporated in the aforesaid binding resin, a reddish tinge such as brown and sepia developed by a characteristic of the black color material is toned, whereby, as a whole, preferable color development relating to gray can be obtained.

### [Method for Forming Image]

The image forming method of the present invention is a method for forming a visible image by repeating two or more times, using toners of different colors, a toner image forming process which forms a toner image which is formed in a manner that an electrostatic latent image formed on an electrostatic latent image bearing body is visualized with toner, and is the method in which one of the above toner image forming processes is carries out using the above-described gray toner of the present invention.

Specifically, for example, included is a method in which a visible image is formed in the following manner: a toner image forming process, in which a toner image, formed in a manner that an electrostatic latent image formed on an electrostatic latent image bearing body is visualized with toner, is directly transferred onto an image support, is carried out by repeating two or more times, using toners of different colors, in which one of the above processes is carries out using the above-described gray toner of the present invention, whereby a color toner image is formed on the image support to obtain an image support bearing the color toner image, which color toner image is then fixed to the image support.

Further, for example, there is also included a so-called intermediate transfer method, in which a visible image is formed in the following manner: a process, in which a toner image, formed in a manner that an electrostatic latent image formed on an electrostatic latent image bearing body is visualized with toner, is transferred onto an intermediate transfer body, is carried out by repeating two or more times, using toners of different colors, in which one of the above processes is carries out using the above-described gray toner of the present invention, and after the color toner image is formed on the intermediate transfer body, the image is transferred onto a image support such as a paper, which is then fixed.

The toner for forming the color toner image includes black toner, yellow toner, magenta toner, and cyan toner, other than the gray toner.

The black toner is composed of black toner particles, in which 3 parts by mass or more of achromatic black color materials, having chroma determined by the above-described method of 5 or less, are incorporated with respect to 100 parts by mass of binding resin, as well as which incorporate no cyan color materials. The black toner particles are preferably particles in which an amount of the black color material is 7 to 12 parts by mass, with respect to 100 parts by mass of binding resin.

The black color material includes the materials which were listed as the black color materials usable for the above-described gray toner.

The yellow toner is composed of yellow toner particles, in which 1 to 10 parts by mass of yellow color materials, in which a hue angle determined by the above-described method is in a range of 45 to 100 degrees, are incorporated with respect to 100 parts by mass of binding resin. The magenta toner is composed of magenta toner particles, in which 1 to 10 parts by mass of magenta color materials, in which a hue angle determined by the above-described method is in ranges of 300 to 360 degrees and 0 to 15 degrees, are incorporated with respect to 100 parts by mass of binding resin.

Each of the yellow and magenta color materials includes various pigments and dyes.

The cyan toner is composed of cyan toner particles, in which 1 to 10 parts by mass of cyan color materials, in which a hue angle determined by the above-described method is in a range of 180 to 220 degrees, are incorporated with respect to 100 parts by mass of binding resin.

The cyan color material includes the materials which were listed as the cyan color materials usable for the above-described gray toner.

Among such image forming methods, an image forming method using 5 colors, black toner, gray toner, yellow toner, magenta toner, and cyan toner, can be carried out, for example, in an image forming apparatus described below.

### [Image Forming Apparatus]

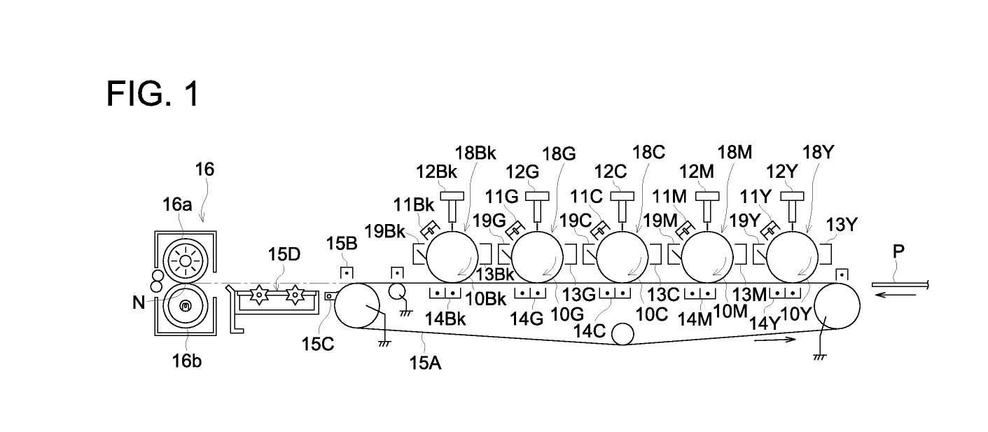

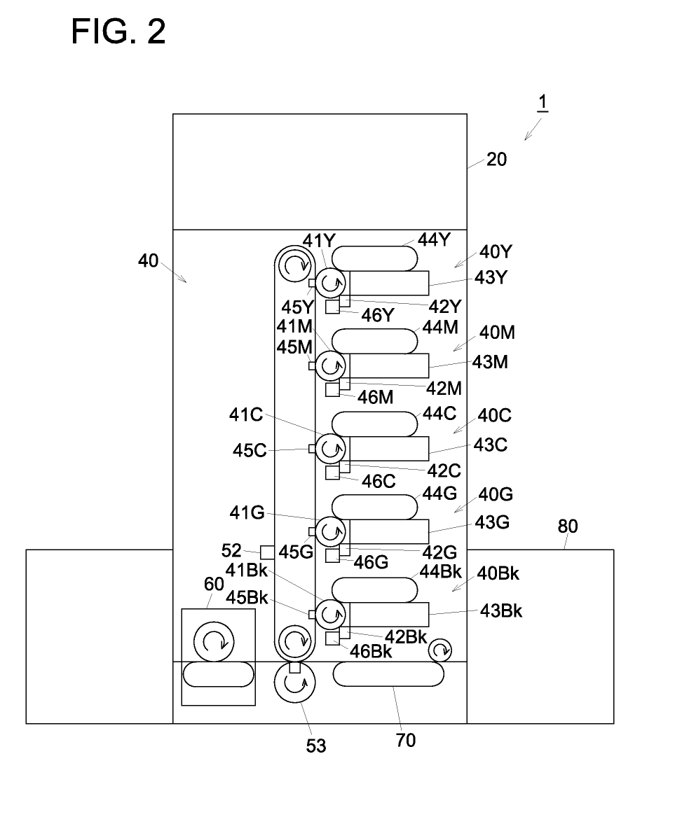

FIG. 1 is a cross section for explanation showing an example of a constitution of an image forming apparatus which is used for an image forming method using the gray toner of the present invention.

The image forming apparatus is a so-called direct transfer system full color image forming apparatus having a constitution in which five image forming units 18Y, 18M, 18C, 18G, 18Bk are arranged along a conveyance belt 15A, and having no intermediate image transfer body.

Each of the image forming units 18Y, 18M, 18C, 18G, and 18Bk is configured such that a photoconductor layer composed of a conductive layer and an organic photoconductor (an OPC) is formed on the periphery of a cylindrical substrate, and is provided with each of photoconductive drums 10Y, 10M, 10C, 10G, and 10Bk, which is a electrostatic latent image bearing body, and is rotated in the clockwise direction, with the conductive layer being grounded, by power from a driving source (not illustrated), or by being moved with the conveyance belt 15; each of chargers 11Y, 11M, 11C, 11G, and 11Bk comprising, for example, a scorotron charger, which provides uniform potential on each of the surfaces of the aforesaid photoconductive drums 10Y, 10M, 10C, 10G, and 10Bk by corona discharge having the same polarity as the toner, and which is arranged in the perpendicular direction to the moving direction of the photoconductive drums 10Y, 10M, 10C, 10G, and 10Bk; each of exposing devices 12Y, 12M, 12C, 12G, and 12Bk comprising, for example, a polygon mirror, which carries out a scanning parallel to a rotating axis of each of the photoconductive drums 10Y, 10M, 10C, 10G, and 10Bk, and forms a latent image by carrying out an image exposure based on image data on each of the surfaces of uniformly charged photoconductive drums 10Y, 10M, 10C, 10G, and 10Bk; and each of developing devices 13Y, 13M, 13C, 13G, and 13Bk, which is provided with a rotating developing sleeves (not illustrated), and conveys toner held on the sleeve to each of the surfaces of the photoconductive drums 10Y, 10M, 10C, 10G, and 10Bk.

In FIG. 1, 19Y, 19M, 19C, 19G, and 10Bk are cleaning devices.

The yellow, magenta, cyan, light gray, and black toner images are formed by the image forming units 18Y, 18M, 18C, 18G, and 18Bk, respectively.

As the conveyance belt 15A which conveys an image support P, usable is a belt, which is provided with conductivity by adding conductive filler, such as carbon black, to polymer film such as film composed of polyimide, polycarbonate, and PVdF, or to synthetic rubber such as silicone rubber, and fluorine rubber. The belt may be a drum shape or a belt shape, but is preferably a belt shape from the viewpoint of expanding the possibility of apparatus design.

It is preferable that the surface of the conveyance belt 15A is made rough to some degree, and for example, the ten-point mean surface roughness Rz is made 0.5 to 2 μm. The rough surface of the conveyance belt 15A as described above ensures close contact between the image support P and the conveyance belt 15A, and prevents fluctuation of the image support P on the conveyance belt 15A, whereby transfer properties of toner images, from the photoconductive drums 10Y, 10M, 10C, 10G, and 10Bk to the image support P, can be favorably achieved.

In such an image forming apparatus, a color toner image is initially formed on the image support P in the following manner: toner images composed of each of the colors formed on each of the photoconductive drums 10Y, 10M, 10C, 10G, and 10Bk of each of the image forming units 18Y, 18M, 18C, 18G, 18Bk are successively transferred and superposed on each other onto the image support P, which is conveyed by the conveyance belt 15A at just a right moment.

The image support P, on which the above color toner image is borne, is separated from the conveyance belt 15A by both discharging action of an AC discharger arranged downstream of the transfer region of the image forming unit 18Bk of the conveyance belt 15A, and separation action of a separation tab 15C arranged at a position with a prescribed spacing from a conveyance section 15D, which separated image support P is then conveyed to the conveyance section 15D, and then, conveyed to a fixing device 16 through the aforesaid conveyance section 15D.

Then, at the fixing device 16, the color toner images superposed on the image support P are fixed by application heat and pressure to the image support P being nipped at a nip portion N formed by a heat roll 16a and pressure roll 16b, after which the image support P carrying the fixed image is ejected outside the apparatus.

In the image forming method of the present invention, in case where a monochrome image is formed using, for example, a black toner and a gray toner, a toner image made of the gray toner (being a gray toner image) is preferably formed on an image support superposing on the previously formed black toner (being a black toner image).

Specifically, in an image forming method by an image forming apparatus of an intermediate transfer system, it is preferable that a developing process of the gray toner is carried out in advance, and subsequently a black toner developing process of the toner is carried out. On the other hand, in an image forming method by an image forming apparatus of a direct transfer system as shown in FIG. 1, it is preferable that a developing process of the black toner is carried out in advance, and subsequently a developing process of the gray toner is carried out.

In case where a color image is formed using, for example, a gray toner together with a yellow toner, a magenta toner and a cyan toner, a toner image made of the gray toner is preferably funned on an image support superposing on toner images having other colors.

In an image forming method by an image forming apparatus of a direct transfer system as shown in FIG. 1, it is preferable that developing processes of each of toners are carried out in a sequence of a yellow toner, a magenta toner, a cyan toner, a gray toner and a black toner.

In case where a color image is formed, due to developing processes in the above sequence, since the degree of image somberness due to color toners placed in the lower layers can be regulated by an amount of gray toner attached and an area ratio of superimposed dots, a visible image of increased expressiveness and a high quality can be formed even in case where a dark grayish tone image and a dark tone image are formed.

According to the image forming method described above, since the above-described gray toner is used, a reddish tinge such as brown and sepia is toned, and thereby a high quality medium tone image, in which an excellent color reproduction is obtained, can be formed. In particular, in case of forming a tone image, in which a little inking is needed, specifically a dark grayish or dark tone image, there can be remarkably obtained an effect to reproduce an expected color tone and form a high quality medium tone image.

In addition, a medium tone image having a rich texture can be formed. It is assumed that this is because an excellent density gradation is formed. Namely, in an achromatic medium tone, when an image takes on a slight tinge of blue, the image is recognized as a shadow, and thereby, a change in lightness can be readily visually taken. According to the image forming method of the present invention, it is assumed that, since toner incorporates a cyan color material, natural shadow is formed.

FIG. 2 shows another example of an image forming apparatus which is used for an image forming method using the gray toner of the present invention.

Image forming device 1 shown in FIG. 2 is an image forming apparatus having transparent toner layer forming unit 400 added to commonly called as a tandem type color image forming device containing a plurality of toner image forming units 40C, 40M, 40Y and 40K, image reader 20, intermediate transfer belt 26, cleaning device 52 transfer device 53, sheet supplier 80 and fixing device 60.

The apparatus includes gray image forming unit 40G to form a gray toner image, yellow image forming unit 40Y to form a yellow toner image, magenta image forming unit 40M to form a magenta toner image, cyan image forming unit 40C to form a cyan toner image, and black image forming unit 40Bk to form a black toner image, each contain a charging electrode (42Y, 42M, 42C, 42G, 42Bk), an exposing member (43Y, 43M, 43C, 43G, 43Bk), a developing member (44G, 44Y, 44M, 44C, 44Bk) and a cleaning member (46Y, 46M, 46C, 46G, 46Bk) each located around a drum shaped photoreceptor (41Y, 41M, 41C, 41G, 41Bk) as an image earner. Each toner image is transferred to intermediate transfer belt 26 by a transfer device (45Y, 45M, 45C, 45G, 45Bk).

In case the image is formed by employing the gray toner of the invention and a black toner, it is preferable that the gray toner image and the black toner image are formed in this order, so that the black toner image is formed closer to the image support (for example, paper) tan the gray toner image.

The color image is formed on a paper by toners of preferably black, gray, yellow, magenta and cyan in an order. Images having high uniform glossiness and improved image of uniformity are obtained.

Image forming apparatus shown in FIGS. 1 and 2 are copy machine for forming electrophotographic color image. The toner of the invention can be used for any electrophotographic image forming apparatus such as a printer and the like.

### [Image Support]

The image support employed in the image forming method using the above gray toner includes a various kinds of supports such as a regular paper including a thin paper and a thick paper, a high-quality paper, a coated printing paper such as an art paper and a coated paper, a commercially available Japanese paper or post card, a plastic film used for OHP, and a cloth.

The gray toner of the present invention and the embodiment of an image forming method using the same were described above, but various modifications can be added to them.

### EXAMPLES

Specific examples of the present invention will be described below.

### Production Example 1 of Toner (Gray Toner) of the Present Invention

### (1) Preparation of Resin Particle A

### (1-1) First Step Polymerization

Into a 5 liter reaction vessel equipped with a stirrer, a temperature sensor, a cooling tube and a nitrogen gas introducing apparatus, added was a solution, which was prepared by dissolving 8 g of sodium dodecyl sulfate into 3 litters of ionized water, and then, the temperature of the resultant solution was raised to 80° C. while stirring at 230 rpm under nitrogen gas flow. After that, a solution, which was prepared by dissolving 10 g of potassium persulfate into 200 g of ionized water, was added, and then, the temperature of the resultant solution was raised again to 80° C. Subsequently, a monomer mixed solution composed of the following materials was dropped over one hour:

| | |
|---|---|
| styrene | 480 g |
| n-butylacrylate | 250 g |
| methacrylic acid | 68.0 g |
| n-octyl-3-mercaptopropionate | 16.0 g |

The resulting solution was polymerized by stirring and heating at 80° C. for two hours, to prepare resin particles [1H]:

### (1-2) Second Step Polymerization

Into a 5 liter reaction vessel equipped with a stirrer, a temperature sensor, a cooling tube and a nitrogen gas introducing apparatus, added was a solution, which was prepared by dissolving 7 g of sodium polyoxyethylene (2) dodecylether sulfate into 800 ml of ionized water, which was then, heated to 98° C. After that, to the above vessel added was a solution, which was prepared by dissolving 260 g of above resin particles [1H] and a monomer mixed solution composed of the following materials:

| | |
|---|---|
| styrene | 245 g |
| n-butylacrylate | 120 g |
| n-octyl-3-mercaptopropionate | 1.5 g |
| paraffin wax (melting point: 45° C.) | 190 g |

The resulting solution was mixed and dispersed over one hour via “CLEARMIX” (manufactured by M-Technique Co., Ltd.), being a mechanical dispersion apparatus equipped with a circulation pathway, to prepare a dispersion liquid containing emulsified particles (oil droplets).

Subsequently, a polymerization initiator solution, which was prepared by dissolving 6 g of potassium persulfate into 200 ml of ionized water, was added to the above dispersion liquid, which solution was then polymerized by stirring and heating at 82° C. over one hour, to prepare resin particles [1 HM].

### (1-3) Third Step Polymerization

Furthermore, a solution, which was prepared by dissolving 11 g of potassium persulfate into 400 ml of ionized water, was added to resin particles [1 HM], and then, a monomer mixed solution composed of the following materials was dropped over one hour at 82° C.:

| | |
|---|---|
| styrene | 435 g |
| n-butylacrylate | 130 g |
| methacrylic acid | 33 g |
| n-octyl-3-mercaptopropionate | 8 g |

After completion of the dropping, the resultant mixed solution was polymerized by heating and stirring over two hours, after which the solution was cooled down to 28° C., to prepare a dispersion of resin particles [A].

### (2) Preparation of Resin Particle B

Into a 5 liter reaction vessel equipped with a stirrer, a temperature sensor, a cooling tube and a nitrogen gas introducing apparatus, added was a solution, which was prepared by dissolving 2.3 g of sodium dodecyl sulfate into 3 litters of ionized water, and then, the temperature of the resultant solution was raised to 80° C. while stirring at 230 rpm under nitrogen gas flow. After that, a solution, which was prepared by dissolving 10 g of potassium persulfate into 200 g of ionized water, was added, and then, the temperature of the resultant solution was raised again to 80° C. Subsequently, a monomer mixed solution composed of the following materials was dropped over one hour:

| | |
|---|---|
| styrene | 520 g |
| n-butylacrylate | 210 g |
| methacrylic acid | 68.0 g |
| n-octyl-3-mercaptopropionate | 16.0 g |

The resulting solution was polymerized by stirring and heating at 80° C. for two hours, to prepare a dispersion of resin particles [B]

### (3) Preparation of Coloring Agent Dispersion

### Preparation Example 1 of Coloring Agent Dispersion

90 g of sodium dodecyl sulfate was dissolved by stirring into 1,400 g of ionized water. While stirring the resultant solution, 420 g of carbon black “REGAL 660R” (manufactured by Cabot Co.) as a coloring agent was gradually added into the solution. Subsequently, the above solution was subjected to a dispersion treatment using a stirring means “CLEARMIX” (manufactured by M-Technique Co., Ltd.), to prepare a dispersion of coloring agent particles (hereinafter, referred to as “coloring agent dispersion [1]”).

### Preparation Examples 2 to 5 of Coloring Agent Dispersion

Coloring agent dispersions [2] to [5] were prepared in a similar manner to preparation example 1 of the coloring agent dispersion except that coloring agents described in Table 1 were used in place of carbon black “REGAL 660R”.

TABLE 1

| Coloring Agent | | |
|---|---|---|
| Dispersion No., | Material | Trade Name (Manufacturer) |
| 1 | CB | REGAL 660R (Cabot Co.) |
| 2 | CB | MA-100S (Mitsubishi Chemical Co.) |
| 3 | Nigrosine Dye | Oil Black HBB (Orient Chemical Ind.) |
| 4 | P.B. 15:3 | Blue B2G (Clariant (Japan) K.K.) |
| 5 | S.B. 63 | Kayaset Blue 714 (Nippon Kayaku |
| | | Co., Ltd.) |

*1: CB: carbon black,
*2: P.B. 15:3: Pigment Blue 15:3,
*3: S.B. 63: Solvent Blue 63

### (4) Production of Toner Particles of the Present Invention

Into a 5 liter reaction vessel equipped with a stirrer, a temperature sensor, a cooling tube and a nitrogen gas introducing apparatus, added were 300 g (equivalent converted to solids) of resin particles [A], 1,400 g of ionized water, 40.7 g of above-described coloring agent dispersion [1], 4.08 g of above-described coloring agent dispersion [4], and a solution, which was prepared by dissolving 3 g of sodium polyoxyethylene (2) dodecylether sulfate into 1,200 ml of ionized water, and then the temperature of the mixture solution was adjusted to 30° C., after which the pH of the solution was adjusted to 10 by adding a 5N aqueous solution of sodium hydroxide. Subsequently, an aqueous solution, which was prepared by dissolving 35 g of magnesium chloride in 35 ml of ionized water, was added in the above solution, while stirring over 10 minutes at 30° C. After standing the solution for 3 minutes, the temperature rising was started and the temperature of the above system was raised to 90° C. over 60 minutes, and then a particle growth reaction was continued while keeping the temperature at 90° C. During the particle growth reaction, the particle size of the coagulated particles was determined using the “COULTER MULTISIZER TA-III” (manufactured by Beckman Coulter Inc.). At a time when the volume based median size reached 3.1 μm, 260 g (equivalent converted to solids) of resin particles [B] was added, and the particle growth reaction was further continued. At a time when the particle size reached to 6.5 μm, an aqueous solution, in which 150 g of sodium chloride was dissolved in 600 ml of ionized water, was added to stop the particle size growth. Furthermore, by heating and stirring at the solution temperature of 98° C. as the fusion-bonding process, the fusion-bonding among particles was continued. After that the solution temperature was cooled down to 30° C., followed by adjustment of pH of the solution to 4.0 by adding hydrochloric acid, and then, the stirring was stopped.

The particles thus prepared were separated from the solution using a basket-type centrifuge “MARK III: model number 60×40” (manufactured by Matsumoto Machine Co., Ltd.) to form a wet cake of toner matrix particles. The above wet cake was rinsed with ionized water at 45° C. using the above-described basket-type centrifuge until an electric conductivity of the filtrate reached 5 μS/cm. After that the rinsed wet cake was transferred to “FLUSH JET DRYER” (manufactured by Seishin Enterprise Co., Ltd.), followed by drying until the moisture content reached 0.5% by mass to prepare toner matrix particles [1].

To the above toner matrix particles [1], added were 1% by mass of hydrophobic silica (a number average primary particle size=12 nm) and 0.3% by mass of hydrophobic titania (a number average primary particle size=20 nm), and then, the mixture was blended using a Henschel mixer, to obtain gray toner [1] of the present invention.

The total amount of binding resin in gray toner [1] is 560 g since a solid content of resin particles [A] is 300 g and a solid content of resin particles [B] is 260 g. On the other hand, a solid content concentration of coloring agent dispersion [1] is 22%, then, the solid content is 9.95 g, and similarly, a solid content concentration of coloring agent dispersion [4] is also 22%, then, the solid content is 0.897 g.

Therefore, in gray toner [1], the content of black color material is 1.6 parts by mass with respect to 100 parts by mass of the binding resin, and the content of cyan color material is 0.16 parts by mass with respect to 100 parts by mass of the binding resin.

### Production Examples 2 to 10 of Toner (Gray Toner) of the Present Invention

Gray toners [2] to [10] were obtained in a similar manner to the production process of toner particles of the present invention of toner production example 1 of the present invention except that the kinds and the additive amount of the coloring agent dispersion to be added were changed according to a prescription shown in Table 2. In Table 2, gray toners [2] to [5] are examples of the present invention, and gray toners [6] to [10] are comparative examples.

TABLE 2

| | No. of Coloring | | | |
|---|---|---|---|---|
| | Agent Dispersion | Additive | No. of Coloring | Additive |
| Toner | of Cyan | Amount | Agent Dispersion of | Amount |
| No. | Color Material | (g) | Black Color Material | (g) |
| 1 | 4 | 4.08 | 1 | 40.70 |
| 2 | 4 | 2.55 | 2 | 51.00 |
| 3 | 5 | 2.55 | 2 | 12.74 |
| 4 | 5 | 12.70 | 2 | 75.50 |
| 5 | 5 | 4.05 | 3 | 40.50 |
| 6 | 4 | 12.70 | 2 | 101.00 |
| 7 | 4 | 15.30 | 2 | 51.00 |
| 8 | 5 | 1.28 | 2 | 2.55 |
| 9 | 5 | 2.30 | 2 | 51.00 |
| 10 | 5 | 2.30 | 3 | 51.00 |

### Production Examples 1 to 10 of Developer

The ferrite carrier covered with a silicone resin having the volume based median size of 60 μm was mixed with each of the above gray toners [1] to [10] using a V-type mixer to a concentration of 6% by mass with respect to each of the toners, to produce gray developers [1] to [10], which function as a developer used for the gray toner.

### Examples 1 to 5, and Comparative Examples 1 to 5

The digital system multi functional printer “bizhub PRO C6500” (manufactured by Konica Minolta Business Technologies Co., Ltd.) was converted such that an image forming unit of gray toner was arranged. Into the converted printer, charged were each of gray developers [1] to [10] thus obtained, and each of commercially available developers, a black developer, a yellow developer, a magenta developer, and a cyan developer used for the bizhub PRO C6500 of the aforesaid multi functional printer, and further, as a toner, each of commercially available toners, a black toner, a yellow toner, a magenta toner, and a cyan toner used for the bizhub PRO C6500. Using the above printer, the following evaluations (1) to (3) were carried out. The results are shown in Table 3.

### (1) Evaluation of Gray Tone

The test chart No. 7 (2008) of the Imaging Society of Japan was printed, which was then evaluated by 50 observers under the same environment (being the same lighting condition and distance) focusing, in particular, on the background of a portrait and a portion of the chart having black gradation. The print was ranked using criteria described below based on the number of observers who evaluated color tinge of a portion of black tone image as being within an achromatic color, that is, the above portion has not, for example, a brown tinge or a red tinge.

### [Evaluation Criteria]

A: 45 or more

B: from 5 to 45

C: 4 or less

Rank A is acceptable.

Chroma C* was determined using the GRETAG MACBETH SPECTROLINO (manufactured by Gretag Macbeth) described above. Chroma value of less than 1.0 is acceptable.

### (2) Color Reproduction of Dark Grayish Tone Image

An image consisting of 8 dark grayish tone patches having color codes: #1e471e, #1e4739, #1e3947, #2c1e47, #471e47, #204a3c, #203c4a, and #22404f, was outputted in a printer mode as a dark grayish tone image. The image, together with a color code comparative sample having each dark grayish tone displayed on a display, was evaluated by 50 observers, who were randomly selected from office workers in Tokyo metropolitan, under the same environment (being the same lighting condition and distance). The color reproduction on the print was evaluated in terms of how much each of the observers noticed a red tinge on the print compared to a comparative sample, and most evaluations using criteria described below were used as the evaluation result.

The display condition was

Computer: iMac manufactured by Apple Computer
Display and Mode: 24 inches Wide Screen LCD, Definition of 1,920×1, 200 pixel

### [Evaluation Criteria]

AA: Observer notices no red tinge to the image, even if comparing it to a comparative sample.

A: Observer notices a slight red tinge to the image, but barely notices it without comparing it with a comparative sample.

B: Observer notices a red slight tinge to the image compared to a comparative sample.

C: Observer clearly notices a red tinge to the image without comparing it with a comparative sample.

### (3) Color Reproduction of Dark Tone Image

An image consisting of 8 dark tone patches having color codes: #36661f, #1f6636, #1f6666, #1f4e66, #1f3666, #361f66, #264D4D, and #336666, was outputted in a printer mode as a dark tone image. The image, together with a color code comparative sample having each dark grayish tone displayed on a display as described above, was evaluated by 50 observers under the same environment (being the same lighting condition and distance). The color reproduction on print was evaluated in terms of how much each of the observers noticed a red tinge on the print compared to a comparative sample, and most evaluations using criteria described below were used as the evaluation result.

### [Evaluation Criteria]

AA: Observer notices no red tinge to the image, even if comparing it to a comparative sample.

A: Observer notices a slight red tinge to the image, but barely notices it without comparing it with a comparative sample.

B: Observer notices a red slight tinge to the image compared to a comparative sample.

C: Observer clearly notices a red tinge to the image without comparing it with a comparative sample.

TABLE 3

| | | To 100 Parts by Mass of | | | | Evaluation Result | | | |
|---|---|---|---|---|---|---|---|---|---|
| | | Binding Resin | | | | Tone Evaluation of | | | |
| | | Amount of | Amount of | Total | | Gray | | Color | Color |
| | | Cy | Bk | Amount | Cy:Bk | Eye | | Reproduction | Reproduction |
| | Toner No. | (parts by mass) | | | (Mass Ratio) | observation | Chroma | of DG | of D |
| Example 1 | 1 | 0.16 | 1.6 | 1.76 | 1:10 | A | 0.5 | AA | AA |
| Example 2 | 2 | 0.1 | 2 | 2.1 | 1:20 | A | 0.9 | AA | A |
| Example 3 | 3 | 0.1 | 0.5 | 0.6 | 1:5 | A | 0.2 | AA | A |
| Example 4 | 4 | 0.5 | 3 | 3.5 | 1:6 | A | 0.4 | A | AA |
| Example 5 | 5 | 0.16 | 1.6 | 1.75 | 1:10 | A | 0.5 | AA | A |
| Comparative | 6 | 0.5 | 4 | 4.5 | 1:8 | C | 1.2 | B | B |
| Example 1 | | | | | | | | | |
| Comparative | 7 | 0.6 | 2 | 2.6 | 1:3.3 | B | 2.0 | C | C |
| Example 2 | | | | | | | | | |
| Comparative | 8 | 0.05 | 0.1 | 0.15 | 1:2 | C | 3.0 | A | C |
| Example 3 | | | | | | | | | |
| Comparative | 9 | 0.09 | 2 | 2.09 | 1:22.2 | C | 5.0 | B | A |
| Example 4 | | | | | | | | | |
| Comparative | 10 | 0.09 | 2 | 2.09 | 1:22.2 | C | 5.0 | A | B |
| Example 5 | | | | | | | | | |

*1: Cy: cyan color material,
*2: Bk: black color material,
*3: Color Reproduction of DG: color reproduction of dark grayish tone image,
*4: Color Reproduction of D: color reproduction of dark tone image

1. An electrostatic image developing toner comprising toner particles containing a binding resin and a coloring agent, wherein
the coloring agent contains a black color material and a cyan color material, and
the content of the black color material is 0.5 to 3 parts by mass with respect to 100 parts by mass of the binding resin, and the content of the cyan color material is 0.1 to 0.5 parts by mass with respect to 100 parts by mass of the binding resin.

2. The electrostatic image developing toner of claim 1, wherein the content ratio of the cyan color material to the black color material is 1:1 to 1:20 by mass ratio.

3. The electrostatic image developing toner of claim 1, wherein the content ratio of the cyan color material to the black color material is 1:2 to 1:15 by mass ratio.

4. The electrostatic image developing toner of claim 1, wherein the black color material is carbon black or black dye.

5. The electrostatic image developing toner of claim 1, wherein an average circular degree of the toner particles, represented by Formula (T), is 0.930 to 1.000.
Circular degree=(Circumference of a circle determined from a diameter equivalent to a circle)/(Circumference of a projected particle image) Formula (T):

6. The electrostatic image developing toner of claim 5, wherein an average circular degree of the toner particles is 0.950 to 0.995.

7. An image forming method by repeating two times or more of a toner image forming step, using different color toners, which step forms a toner image which is formed by visualizing an electrostatic latent image formed on an electrostatic latent image bearing body using toner,
wherein one of two or more toner image forming steps is carried out using the electrostatic image developing toner of claim 1.

8. The image forming method of claim 7, which comprises a step of forming an image by using a black color toner.

9. The image forming method of claim 8, a black color toner image, and the electrostatic image developing toner of claim 1 are formed on an image support in this order.

10. The image forming method of claim 8, which further comprises steps of forming images by using a yellow color toner, a magenta color toner, and a cyan color toner, respectively.

11. The image forming method of claim 10, wherein a black color toner image, the electrostatic image developing toner of claim 1, a cyan color toner image, a magenta color toner image, and a yellow color toner image are formed on an image support in this order.
